(19) United States
(12) Patent Application Publication
(10) Pub. No.: US 2026/0025412 A1
(43) Pub. Date: Jan. 22, 2026

(54) STATIC INTERNET PROTOCOL (IP) ADDRESS ASSIGNMENT FOR EDGE-BASED SECURITY SERVICES IN COMMUNICATION NETWORKS

(71) Applicant: T-MOBILE INNOVATIONS LLC, Overland Park, KS (US)

(72) Inventors: Anis Adil Anis, Bay Point, CA (US); Nathan Paul Wilhoft, Shawnee, KS (US); Cristian Asandului, Snoqualmie, WA (US); Brent Matthew Johnston, Ardmore, AL (US); David Christopher Baldwin, Dublin, CA (US); Vinodkumar Sundarraj, Pleasanton, CA (US)

(21) Appl. No.: 18/776,772

(22) Filed: Jul. 18, 2024

(51) Int. Cl. H04L 9/40; H04L 61/5007; H04W 8/18; H04W 12/06; H04W 12/72

(52) U.S. Cl. CPC H04L 63/20; H04L 61/5007; H04W 8/186; H04W 12/06; H04W 12/72

(57) ABSTRACT

Various embodiments include a wireless communication network that comprises a network controller, an authentication server, and a user plane. The network controller authenticates a subscriber Identifier (ID) for a user device received in a registration request. In response to authentication, the network controller detects that the user device qualifies for an edge-based security service and static Internet Protocol (IP) address assignment. The authentication server maps the subscriber ID for the user device to a static IP address and assigns the static IP address to the device. The user plane provides the static IP address and the subscriber ID to the edge-based security service. The user plane exchanges user data with the user device and with the edge-based security service. The edge-based security service enforces security policies for the data session of the user device on the communication network.

### TECHNICAL FIELD

Various embodiments of the present technology relate to user authentication, and more specifically, to assigning static Internet Protocol (IP) addresses to user devices for edge-based security services.

### BACKGROUND

Wireless communication networks provide wireless data services to wireless user devices. Exemplary wireless data services include voice calling, video calling, internet-access, media-streaming, online gaming, social-networking, and machine-control. Exemplary wireless user devices comprise phones, computers, vehicles, robots, and sensors. Radio Access Networks (RANs) exchange wireless signals with the wireless user devices over radio frequency bands. The wireless signals use wireless network protocols like Fifth Generation New Radio (5GNR), Long Term Evolution (LTE), Institute of Electrical and Electronic Engineers (IEEE) 802.11 (WIFI), and Low-Power Wide Area Network (LP-WAN). The RANs exchange network signaling and user data with network elements that are often clustered together into wireless network cores over backhaul data links. The core networks execute network functions to provide wireless data services to the wireless user devices.

Edge based security services provide security controls at a point of access instead of routing traffic to a data center where security policies are enforced. Points of access may include a user device, an Internet-of-Things (IoT) device, an access network, an edge computing location, and the like. Secure Access Service Edge (SASE) is a type of edge-based security service. SASE ensures real-time, context aware policy enforcement to secure user and device traffic. SASE comprises a flexible zero trust architecture that enforces security policies on data sessions between user devices and enterprise networks and/or the public internet. SASE encompasses a range of security solutions, including Zero Trust Network Access (ZTNA), Secure Web Gateways (SWG), Cloud Access Security Brokers (CASB), Firewall as a Service (FWaaS), and the like. This integrated approach allows SASE to provide secure and optimized connectivity to cloud services, applications, and resources from any location or device. SASE routes traffic to user devices based on the device's Internet Protocol (IP) address.

Wireless communication networks assign IP addresses to user devices during a process referred to as registration. Each time a device attaches to the network, the device registers with the network for wireless service. The network assigns the device an IP address in response to the registration. The network uses the IP address to route data to the device. When the device detaches from the network, the network deregisters the device for service and the IP address for the device is removed. Consequently, device IP addresses change over time. The dynamically changing IP addresses of user devices may make it difficult for edge-based security services like SASE to route traffic to devices over wireless communication networks.

### OVERVIEW

This Overview is provided to introduce a selection of concepts in a simplified form that are further described below in the Technical Description. This summary is not intended to identify key features or essential features of the claimed subject matter, nor is it intended to be used as an aid in determining the scope of the claimed subject matter.

Various embodiments of the present technology relate to solutions for user authentication. Some embodiments comprise a method. The method comprises authenticating, by a control plane in a communication network, a subscriber Identifier (ID) for a user device received in a registration request. The method further comprises, in response to authentication, detecting, by the control plane, that the user device qualifies for an edge-based security service and static Internet Protocol (IP) address assignment. The method further comprises mapping, by an authentication server in the communication network, the subscriber ID for the user device to a static IP address and assigning the static IP address to the device. The method further comprises providing, by a user plane in the communication network, the static IP address and the subscriber ID to the edge-based security service. The method further comprises exchanging, by the user plane, user data with the user device and with the edge-based security service. The edge-based security service enforces security policies for a data session of the user device on the communication network.

Some embodiments comprise a communication network. The communication network comprises a network controller, an authentication server, and a user plane. The network controller authenticates a subscriber ID for a user device received in a registration request. In response to authentication, the network controller detects that the user device qualifies for an edge-based security service and static IP address assignment. The authentication server maps the subscriber ID for the user device to a static IP address and assigns the static IP address to the device. The user plane provides the static IP address and the subscriber ID to the edge-based security service. The user plane exchanges user data with the user device and with the edge-based security service. The edge-based security service enforces security policies for the data session of the user device on the communication network.

Some embodiments comprise one or more non-transitory computer readable storage media having program instructions stored thereon. When executed by a computing system, the program instructions direct the computing system to perform operations. The operations comprise authenticating an International Mobile Subscriber Identity (IMSI) for a user device received in a registration request sent by the user device. The operations further comprise, in response to authentication, accessing a subscriber profile and determining the user device qualifies for an edge-based security service and static IP address assignment. The operations further comprise mapping the IMSI for the user device to a static IP address and assigning the static IP address to the user device. The operations further comprise providing the static IP address and the IMSI to the edge-based security service. The operations further comprise exchanging user data with the user device and with the edge-based security service for a data session of the user device on the communication network. The edge-based security service enforces security policies for a data session of the user device on the communication network.

### DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a communication network.

FIG. 2 illustrates an exemplary operation of the communication network.

FIG. 3 illustrates another exemplary operation of the communication network.

FIG. 4 illustrates a Fifth Generation (5G) communication network.

FIG. 5 illustrates network functions in the 5G communication network.

FIG. 6 illustrates a Network Function Virtualization Infrastructure (NFVI) in the 5G communication network.

FIG. 7 further illustrates the NFVI in the 5G communication network.

FIG. 8 illustrates an exemplary operation of the 5G communication network.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### TECHNICAL DESCRIPTION

The following description and associated figures teach the best mode of the invention. For the purpose of teaching inventive principles, some conventional aspects of the best mode may be simplified or omitted. The following claims specify the scope of the invention. Note that some aspects of the best mode may not fall within the scope of the invention as specified by the claims. Thus, those skilled in the art will appreciate variations from the best mode that fall within the scope of the invention. Those skilled in the art will appreciate that the features described below can be combined in various ways to form multiple variations of the invention. As a result, the invention is not limited to the specific examples described below, but only by the claims and their equivalents.

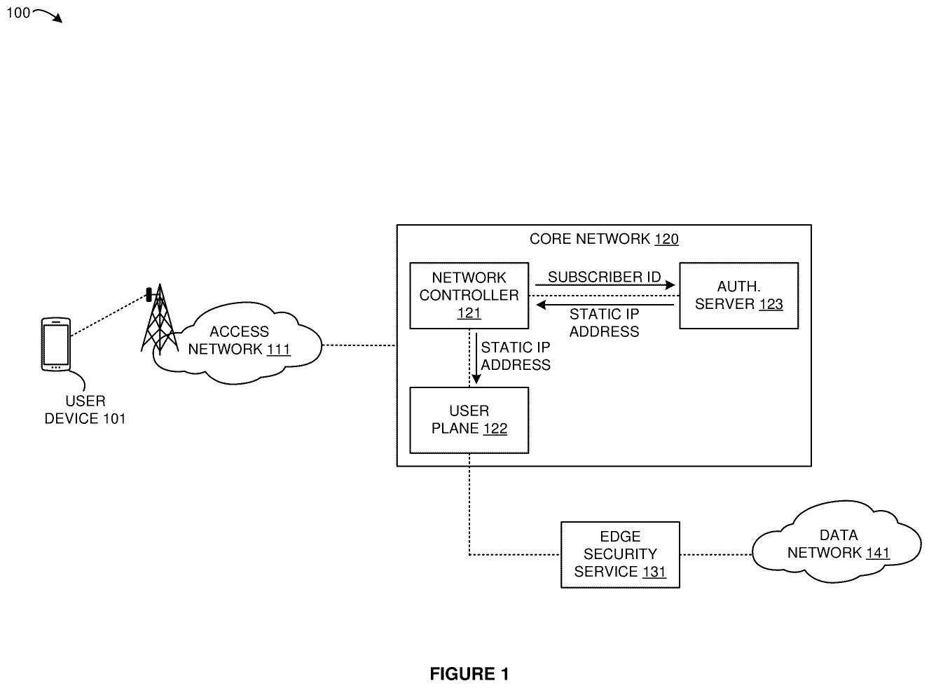

FIG. 1 illustrates communication network 100 to assign static Internet Protocol (IP) addresses for edge-based security service. Communication network 100 provides services like media-streaming, internet-access, voice/video calling, text messaging, machine communications, or some other wireless communications product. Communication network 100 comprises user device 101, access network 111, core network 120, edge security service 131, and data network 141. Core network 120 comprises network controller 121, user plane 122, and authentication server 123. In other examples, communication network 100 may comprise additional or different elements than those illustrated in FIG. 1.

Various examples of network operation and configuration are described herein. In some examples, user device 101 attaches to core network 120 over access network 111. User device 101 transfers a registration request to network controller 121 over access network 111 to register for service on communication network 100. The registration request includes a subscriber Identifier (ID). Exemplary subscriber IDs include Subscriber Concealed Identifier (SUCI), Subscriber Permanent Identifier (SUPI), International Mobile Subscriber Identifier (IMSI), Fifth Generation Global Unique Temporary Identifier (5G-GUTI), and the like. Network controller 121 receives the registration request and authenticates the subscriber ID indicated by user device 101. Responsive to authentication, network controller 121 authorizes user device 101 for service on network 100 and detects that user device is subscribed for static IP address assignment and edge-based security service. In response, network controller 121 forwards the subscriber ID to authentication server 123. Authentication server 123 performs a secondary authentication of user device 101. Authentication server 123 maps the subscriber ID for user device 101 to a static IP address and indicates the static IP address to network controller 121. Static IP assignments are IP addresses that are reserved for a specific device and do not change. This contrasts with dynamic IP addresses, which are assigned to devices on a temporary basis and can change over time. Static IP assignments can be useful for a variety of purposes, including remote device management, hosting servers, and running certain applications. Network controller 121 assigns the static IP address to user device 101 to use for data sessions on network 100. Network controller 121 indicates the static IP address to user device 101 and to user plane 122. User plane 122 forwards the IP address and subscriber ID for user device 101 to edge security service 131. User device begins a data session on network 100. User device 101 exchanges user data for the session with user plane 122 over access network 111. User plane 122 exchanges the user data with edge security service 131. Edge security service 131 enforces security polices (e.g., malware detection) on the session and exchanges the data with data network 141.

Advantageously, wireless communication network 100 effectively and efficiently selects and allocates static IP addresses to user devices to facilitate communication between the user devices and the edge security services. Moreover, by utilizing static IP address assignments, wireless communication network 100 increases network 100 and edge security service's ability to support remote device management, hosting servers, and running certain applications.

User device 101 comprises a vehicle, drone, robot, computer, phone, sensor, or another type of data appliance with wireless and/or wireline communication circuitry. User device 101 and access network 111 communicate over links using wireless/wireline technologies like Sixth Generation Radio (6GR), Fifth Generation New Radio (5GNR), Long Term Evolution (LTE), Institute of Electrical and Electronic Engineers (IEEE) 802.11 (WIFI), Low-Power Wide Area Network (LP-WAN), Bluetooth, and/or some other type of wireless networking protocol. The wireless technologies use electromagnetic frequencies in the low-band, mid-band, high-band, or some other portion of the electromagnetic spectrum. The wired connections comprise metallic links, glass fibers, and/or some other type of wired interface.

Although access network 111 is illustrated as a tower, access network 111 may comprise another type of mounting structure (e.g., a building), or no mounting structure at all. Access network 111 comprises a Sixth Generation (6G) Radio Access Network (RAN), Fifth Generation (5G) RAN, LTE RAN, gNodeB, eNodeB, NB-IoT access node, trusted non-Third Generation Partnership Project (3GPP) access node, untrusted non-3GPP access node, LP-WAN base station, wireless relay, WIFI hotspot, Bluetooth access node, and/or another wireless or wireline network transceiver. Access network 111 exchanges network signaling and user data with network controller 121 and user plane 122 clustered together into core network 120. Access network 111 is connected to core network 120 over backhaul data links. Access network 111 and core network 120 may communicate via edge networks like internet backbone providers, edge computing systems, or another type of edge system to provide the backhaul data links between access network 111 and core network 120.

Access network 111 may comprise Radio Units (RUs), Distributed Units (DUs) and Centralized Units (CUs). The RUs may be mounted at elevation and have antennas, modulators, signal processors, and the like. The RUs are connected to the DUs which are usually nearby network computers. The DUs handle lower wireless network layers like the Physical Layer (PHY), Media Access Control (MAC), and Radio Link Control (RLC). The DUs are connected to the CUs which are larger computer centers that are closer to the network cores. The CUs handle higher wireless network layers like the Radio Resource Control (RRC), Service Data Adaption Protocol (SDAP), and Packet Data Convergence Protocol (PDCP). The CUs are coupled to network functions in core network 120. Access network 111 may comprise Baseband Units (BBUs). The BBUs handle lower and higher network layers like RRC, PDCP, RLC, MAC, and PHY. The BBUs are coupled to network entities in core network 120.

Core network 120 is representative of computing systems that provide wireless data services to user device 101 over access network 111. Exemplary computing systems comprise Network Function Virtualization Infrastructure (NFVI) systems, data centers, server farms, cloud computing networks, hybrid cloud networks, and the like. Core network 120 may comprise a 3GPP core network architecture like Sixth Generation Core (6GC), Fifth Generation Core (5GC), Evolved Packet Core (EPC), and/or another type of 3GPP core network architecture. Access network 111, core network 120, edge security service 131, and data network 141 communicate over various links that use metallic links, glass fibers, radio channels, or some other communication media. The links use 6GC, 5GC, EPC, IEEE 802.3 (ENET), Time Division Multiplex (TDM), Data Over Cable System Interface Specification (DOCSIS), Internet Protocol (IP), General Packet Radio Service Transfer Protocol (GTP), 6GR, 5GNR, LTE, WIFI, virtual switching, inter-processor communication, bus interfaces, and/or some other data communication protocols. The computing systems of core network 120 store and execute the network functions/entities to form network controller 121, user plane 122, and authentication server 123. Network controller 121 may comprise control plane network functions/entities like Access and Mobility Management Function (AMF), Session Management Function (SMF), Authentication Server Function (AUSF), Unified Data Management (UDM), Mobility Management Entity (MME), and Home Subscriber Server (HSS). User plane 122 comprises network functions/entities like User Plane Function (UPF), Serving Gateway (S-GW), Packet Gateway (P-GW). Authentication server 123 comprises network functions/entities like Authentication, Authorization, and Accounting (AAA) server and the like.

Edge security service 131 comprises a cloud-based computing system that applies security policies on sessions between core network 120 and data network 141. Edge security service 131 may comprise a Secure Access Service Edge (SASE). In other examples, edge security service 131 may provide another type of edge-based service (e.g., content distribution). Data network 141 comprises an Application Server (AS) that hosts applications (e.g., media streaming applications, messaging SMS applications, etc.) for user device 101.

User device 101 and access network 111 comprise antennas, amplifiers, filters, modulation, analog/digital interfaces, microprocessors, software, memories, transceivers, bus circuitry, and the like. User device 101, access network 111, core network 120, edge security service 131, and data network 141 comprise microprocessors, software, memories, transceivers, bus circuitry, and the like. The microprocessors comprise Digital Signal Processors (DSP), Central Processing Units (CPU), Graphical Processing Units (GPU), Application-Specific Integrated Circuits (ASIC), Field Programmable Gate Array (FPGA), and/or the like. The memories comprise Random Access Memory (RAM), flash circuitry, disk drives, and/or the like. The memories store software like operating systems, user applications, radio applications, and network functions. The microprocessors retrieve the software from the memories and execute the software to drive the operation of wireless communication network 100 as described herein.

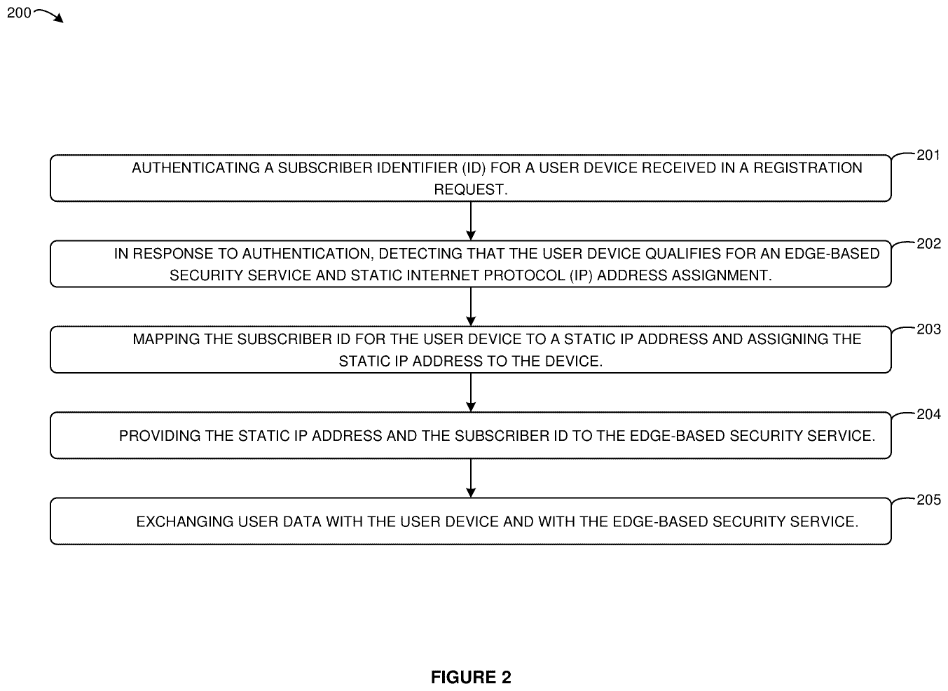

FIG. 2 illustrates process 200. Process 200 comprises an exemplary operation of communication network 100 to assign static IP addresses for edge-based security service. The operation may vary in other examples. The operations of process 200 comprise authenticating a subscriber ID for a user device received in a registration request (step 201). The operations further comprise, in response to authentication, detecting that the user device qualifies for an edge-based security service and static IP address assignment (step 202). The operations further comprise mapping the subscriber ID for the user device to a static IP address and assigning the static IP address to the user device (step 203). The operations further comprise providing the static IP address and the subscriber ID to the edge-based security service (step 204). The operations further comprise exchanging user data with the user device and with the edge-based security service. The edge-based security service enforces security policies for the data session of the user device on the communication network.

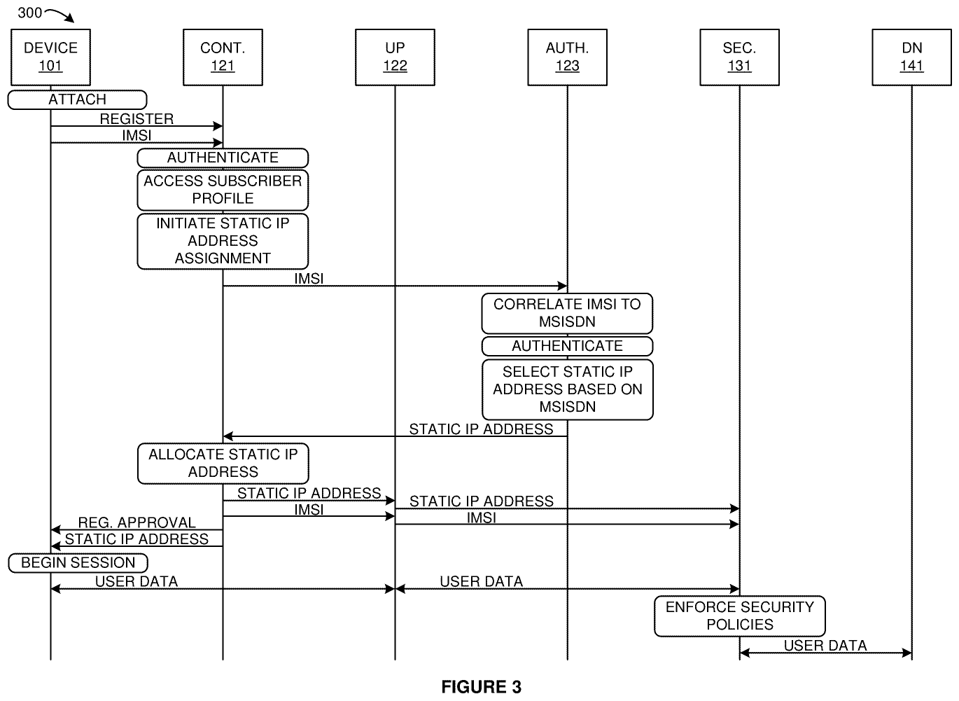

FIG. 3 illustrates process 300. Process 300 comprises an exemplary operation of wireless communication network 100 to assign static IP addresses for edge-based security service. Process 300 comprises an example of process 200 illustrated in FIG. 2, however process 200 may differ. The operation may vary in other examples. In some examples, user device 101 attaches to access network 111. User device 101 and access network 111 implement a Random Access Channel (RACH) process to establish a default signaling link for user device 101. Once the signaling link is established, user device 101 transfers a NAS registration request to network controller (CONT.) 121 over access network 111 via the default signaling link. The registration request includes information like a registration type, Internation Mobile Subscriber Identifier (IMSI), Tracking Arca ID (TAI), Network Slice Selection Assistance Information (NSSAI) requests, UE capabilities, Protocol Data Unit (PDU) session requests, and the like.

Network controller 121 authenticates the identity of user device 101 and authorizes user device 101 for wireless service. In response to authentication and authorization, network controller 121 accesses a subscriber profile for user device 101 stored by a network data system, such as a subscriber information database of the wireless communication network 100. The subscriber profile comprises a set of subscriber attributes that indicate authorized service for user device 101. In this example, the subscriber attributes indicate user device 101 is subscribed for secondary authentication, static IP address assignment, and edge-based security service. Network controller 121 initiates static IP address assignment based on the subscriber attributes. Network controller 121 transfers a request to authentication server 123 that requests secondary authentication, static IP address selection, and indicates the IMSI of user device 101.

Authentication server (AUTH.) 123 receives the request and correlates the IMSI for user device 101 with a Mobile Station International Subscriber Directory Number (MSISDN) associated with data network (DN) 141. Authentication server 123 authenticates user device 101 based on the correlation. For example, authentication server 123 may authenticate devices that provide an IMSI correlated with an MSISDN associated with data network 141 and may avoid authenticating devices that provide IMSIs that are not correlated with MSISDNs associated with data network 141. Authentication server 123 maintains a pool of static IP addresses that are reserved for devices associated with data network 141. In response to authentication, authentication server 123 selects a static IP address for user device 101 from the pool of static IP addresses and stores a binding that associates the selected static IP address with the MSISDN of user device 101. The selected static IP address is removed from the pool of available static IP responsive to selection. Authentication server 123 returns the selected static IP address to network controller 121. Network controller 121 allocates the static IP address to user device 101. Network controller 121 forwards the IMSI and static IP address to edge security service (SEC.) 131 over user plane (UP) 122. Network controller 121 transfers a registration approval message to user device 101. The registration approval comprises data like the static IP address, network controller ID, access network ID, bit rate, session setup information, selected network slices, and the like.

In response to the registration approval message, user device 101 begins a session over network 100 with data network 141. User device 101 exchanges user data with user plane 122. User plane 122 exchanges the user data with edge security service 131. Edge security service 131 enforces security policies on the packet flow. For example, edge security service 131 may perform content filtering, session security, malware scanning, Domain Name System (DNS) filtering, firewall, intrusion detection and the like. Edge security service 131 exchanges the user data with data network 141. Data network 141, edge security service 131, and user plane 122 route data to user device 101 over network 100 based on the static IP address.

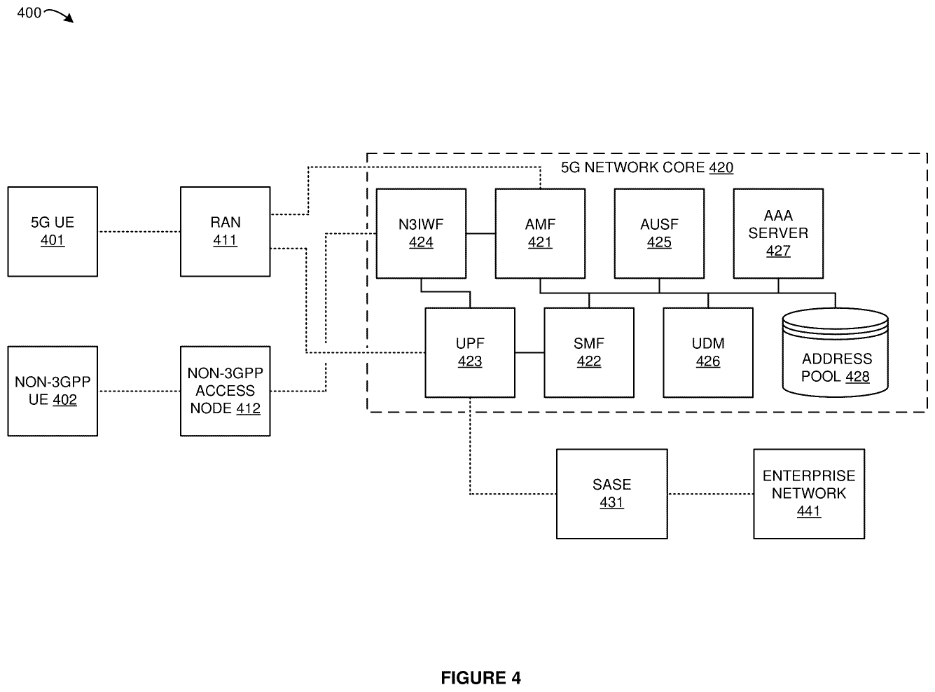

FIG. 4 illustrates 5G communication network 400 to assign static IP addresses for edge-based security service. 5G communication network 400 comprises an example of communication network 100 illustrated in FIG. 1, however network 100 may differ. 5G communication network 400 comprises 5G User Equipment (UE) 401, non-Third Generation Partnership Project (3GPP) UE 402, 5G RAN 411, non-3GPP access node 412, 5G network core 420, SASE 431, and enterprise network 441. 5G network core 420 comprises AMF 421, SMF 422, UPF 423, non-3GPP Interworking Function (N3IWF) 424, AUSF 425, UDM 426, AAA server 427, and address pool 428. Other network functions and network entities like Network Slice Selection Function (NSSF), Policy Control Function (PCF), Unified Data Registry (UDR), Home Subscriber Register (HLR), Network Repository Function (NRF), Short Message Service Function (SMSF), Network Exposure Function (NEF), Application Function (AF), Equipment Identity Register (EIR), and Session Communication Proxy (SCP) are typically present in 5G network core 420 but are omitted for clarity. In other examples, 5G communication network 400 may comprise different or additional elements than those illustrated in FIG. 4.

In some examples, UE 401 wirelessly attaches to 5G RAN 411 over a 5GNR link. UE 401 is a wireless user device associated with enterprise network 441. UE 401 undergoes a RACH procedure with 5G RAN 411 to establish a secure signaling channel. UE 401 transfers a registration request to AMF 421 over 5G RAN 411. The registration request indicates a registration type, 5G-GUTI, TAI, NSSAI requests, UE capabilities, requests for PDU sessions with enterprise network 441, and the like. In response to the registration request, AMF 421 transfers a NAS identity request to UE 401 over a NAS signaling link between UE 401 and AMF 421 that traverses RAN 411. UE 401 indicates its SUCI to AMF 421 over the NAS link that traverses 5G RAN 411. AMF 421 transfers an authentication request to AUSF 425 to retrieve authentication vectors to authenticate UE 401. The request comprises the SUCI for UE 401. AUSF 425 indicates the SUCI and requests authentication vectors from UDM 426. UDM 426 accesses the subscriber profile for UE 401 and derives the SUPI for UE 401 based on the SUCI. The SUPI comprises the IMSI associated with the Subscriber Identity Module (SIM) card for UE 401. UDM 426 generates authentication vectors for UE 401. UDM 426 returns the vectors and SUPI to AUSF 425. The authentication vectors comprise a random number, expected result, key selection criteria, and the like. AUSF 425 forwards the SUPI and authentication vectors to AMF 421. AMF 421 transfers an authentication challenge that comprises the random number and key selection criteria to UE 401 over the NAS link that traverses RAN 411. UE 401 hashes random number with its secret key to generate an authentication result and indicates the authentication result to AMF 421 over the NAS link. AMF 421 matches the expected result retrieved from AUSF 425 with the authentication result received from UE 401 to authenticate UE 401.

Responsive to the authentication, AMF 421 transfers a context registration request to UDM 426 that includes AMF ID, a supported feature list, a Permanent Equipment Identifier (PEI) for UE 401, and the like. UDM 426 indicates successful UDM registration to AMF 421. In response, AMF 421 requests access and mobility subscription data, SMS selection subscription data, and UE context in SMF data from UDM 426. UDM 426 accesses the subscriber profile for UE 401 and returns the requested data. The access and mobility subscription data comprises a supported feature list for UE 401 (e.g., Quality of Service Class Indicator (QCI), Aggregate Maximum Bit Rate (AMBR), latency, voice/video calling, internet access, etc.), a General Public Subscription Identifier (GPSI) array, slice selection information, and the like. The SMF selection data comprises a supported feature list, and a list of S-NSSAIs and associated information. The UE context in SMF data comprises PDU session and EPC interworking information. The access and mobility subscription data, SMS selection subscription data, and/or UE context in SMF data indicates UE 401 is subscribed for secondary authentication with AAA server 427, static IP address assignment, and edge-based security service over SASE 431. For example, the SUPI of UE 401 may comprise a network specific identity code associated with enterprise network 441. AMF 421 forms the UE context for UE 401 using the retrieved information. The UE context defines the authorized services for UE 401.

In some examples, AMF 421 may transfer a policy creation request to a PCF (not illustrated) to create a policy association for UE 401. The PCF may respond to the request with policy association information like the SUPI, GPSI, PEI, and user location information for UE 401. The PCF may subscribe to AMF 421 for event reporting like user location updates, registration state changes, communication failure events, and the like. AMF 421 may create a PCF subscription based on the policy association information and signal to the PCF of the successful subscription creation.

AMF 421 may select one or more network slices for UE 401 based on the slice selection information. Wireless network slices typically comprise collections core network and RAN resources that have capabilities to provide service types (e.g., low-latency service) to UEs. For example, AMF 421 may interface with an NSSF to select a security slice for SASE user for UE 401. The selected security slice may comprise UPF 423, portions of RAN 411, and/or other elements in network 400. This SASE security slice creates a dedicated virtual network segment for security services, enabling efficient data traffic management and routing for security purposes. With the security slice, users can access their data with enhanced security, efficiency, and seamless experience.

AMF 421 selects SMF 422 to serve UE 401 based on SMF selection data received from UDM 426 (and in some examples the network policies received from the PCF). AMF 421 transfers a list of requested PDU sessions with enterprise network 441 (as received during the registration request), a PDU session activation command, and the SUPI (that includes UE 401's IMSI) to SMF 422. AMF 421 indicates that UE 401 is subscribed for secondary authentication, static IP address assignment, and service over SASE 431.

SMF 422 receives the PDU session list, session activation command, and the SUPI from AMF 421. SMF 422 selects UPF 423 to support the PDU sessions based on the received data. SMF 422 initiates secondary authentication with AAA server 427 and static IP address assignment based on the indication from AMF 421. AAA server 427 is representative of a network entity associated with enterprise network 441 to authenticate and authorize PDU sessions with enterprise network 441. Although illustrated as being located in 5G network core 420, in some examples AAA server 427 may instead be located in enterprise network 441. When located in enterprise network 441, SMF 422 may communicate with AAA server 427 over UPF 423 and an AAA server proxy. When located in core network 420 (as illustrated in FIG. 4), SMF 422 may communicate with AAA server 427 directly. AAA server 427 operates similarly whether located in core network 420 or enterprise network 441.

SMF 422 transfers a secondary authentication request to AAA server 427. The request indicates the IMSI of and requests static IP address assignment for UE 401. AAA server 427 receives the request and interfaces with address pool 428 to authenticate/authorize the PDU session for UE 401. Address pool 428 maintains a registry that associates IMSIs for devices associated with enterprise network 441 with MSISDNs, associates MSISDNs with assigned static IP addresses, and maintains a pool of available static IP addresses for devices associated with enterprise network 441. AAA server 427 correlates the IMSI with one of the MSISDNs to authenticate and authorize UE 401 for a PDU session with enterprise network 441. AAA server 427 selects a static IP address for UE 401 from the pool of available static IP addresses responsive to the correlation of UE 401's IMSI with an MSISDN associated with enterprise network 441. AAA server 427 creates a binding between the selected static IP address, the IMSI of UE 401, and the MSISDN of UE 401 and stores the binding on address pool 428. AAA server 427 transfers an authorization message for UE 401's PDU session with enterprise network 441 to SMF 422. The authorization message comprises the static IP address, the MSISDN for UE 401, a PDU session authorization, and data like policy and charging information, list of allowed Media Access Control (MAC) addresses, list of allowed Virtual Local Area Network (VLAN) tags, authorized session Aggregate Maximum Bit Rate (AMBR), routing information, and the like.

SMF 422 receives the authorization message from AAA server 427. SMF 422 allocates the static IP addresses to UE 401 for the requested PDU sessions and allocates Tunnel End Point ID (TEID) for the session. SMF 422 transfers a session modification request that includes a session endpoint identifier, static IP address, MSISDN, session start/stop information, and TEID to UPF 423 to setup the default bearer for UE 401. The default bearer is a link to carry IP packets between UE 401 and enterprise network 441 over SASE 431. The default bearer traverses 5G RAN 411, UPF 423, SASE 431, and enterprise network 441. UPF 423 sets up a default bearer between UE 401, SASE 431, and enterprise network 441. UPF 423 transfers an accounting message to SASE 431 to enable edge-based security for UE 401. The accounting message includes the IMSI, MSISDN, session start data, session end data, and the like. SASE 431 receives the accounting message and selects security policies based on the received data. For example, SASE 431 may host a data structure that associates UE IMSIs with security policies, input UE 401's IMSI into the data structure, and select intrusion detection and prevention policies for the PDU session based on the output from the data structure.

SMF 422 notifies AMF 421 that the default bearer is set up. In response, AMF 421 registers UE 401 for service on network 400. AMF 421 generates a registration accept message that includes the allocated static IP addresses for UE 401, RAN IDs, AMBR, Globally Unique AMF ID (GUAMI), PDU session data, S-NSSAI list, security data, and the like. AMF 421 transfers the registration accept message to UE 401 over the NAS link that traverses RAN 411. UE 401 receives the registration accept message and launches a user application to begin the PDU session(s) with enterprise network 441. The application generates uplink data and UE 401 wirelessly transfers the uplink data for the PDU session to UPF 423 over the default bearer that traverses RAN 411. UPF 423 routes the uplink data to SASE 431. SASE 431 receives the uplink data and enforces the selected security policies on the uplink data. For example, SASE 431 may perform content filtering, session security, malware scanning, DNS filtering, firewall, intrusion detection and prevention, and the like on the PDU session. SASE 431 forwards the uplink data after enforcement of the security policies to enterprise network 441. Enterprise network 441 generates and transfers downlink data for the PDU session to SASE 431 based on the static IP address (or another identifier like MSISDN) for UE 401. SASE 431 enforces the security policies on the downlink data and forwards the secure downlink data to UPF 423. UPF 423 routes the downlink data to UE 401 over the default bearer that traverses RAN 411 based on the static IP address. In some examples, UPF 423 and SASE 431 may route the uplink/downlink traffic for specific applications executing on UE 401.

Similar to UE 401, non-3GPP UE 402 attaches to non-3GPP access node 412. For example, non-3GPP UE 402 may comprise a Wifi only IoT device associated with enterprise network 441. Non-3GPP access node 412 provides non-3GPP wireless and/or wireline links like Wifi, Ethernet, and Bluetooth. UE 402 transfers a registration request to AMF 421 over non-3GPP access node 412 and N3IWF 424. AMF 421, AUSF 425, and UDM 426 authenticate and authorize UE 402 for service similarly to the process described above for UE 401. SMF 422 interfaces with AAA server 427 to authenticate and authorize UE 402's PDU session with enterprise network 441 and select a static IP address for UE 402 similarly to the process described above for UE 401. SMF 422 allocates the selected static IP address for UE 402 and directs UPF 423 to serve UE 402. UPF 423 transfers an accounting message that includes the static IP address, MSISDN, session start/stop times, and the like to SASE 431 to enable edge security service for UE 402's PDU session. SMF 422 notifies AMF 421 that the session is ready to begin. AMF 421 transfers a registration accept message that includes the static IP address and other data for UE 402 to use to begin the PDU session to UE 402 over N3IWF 424 and non-3GPP access node 412. UE 402 begins the PDU session and exchanges data with UPF 423 over non-3GPP access node 412 and N3IWF 424. UPF 423 exchanges the data with SASE 431. SASE 431 enforces security policies on the data and exchanges the data with enterprise network 441.

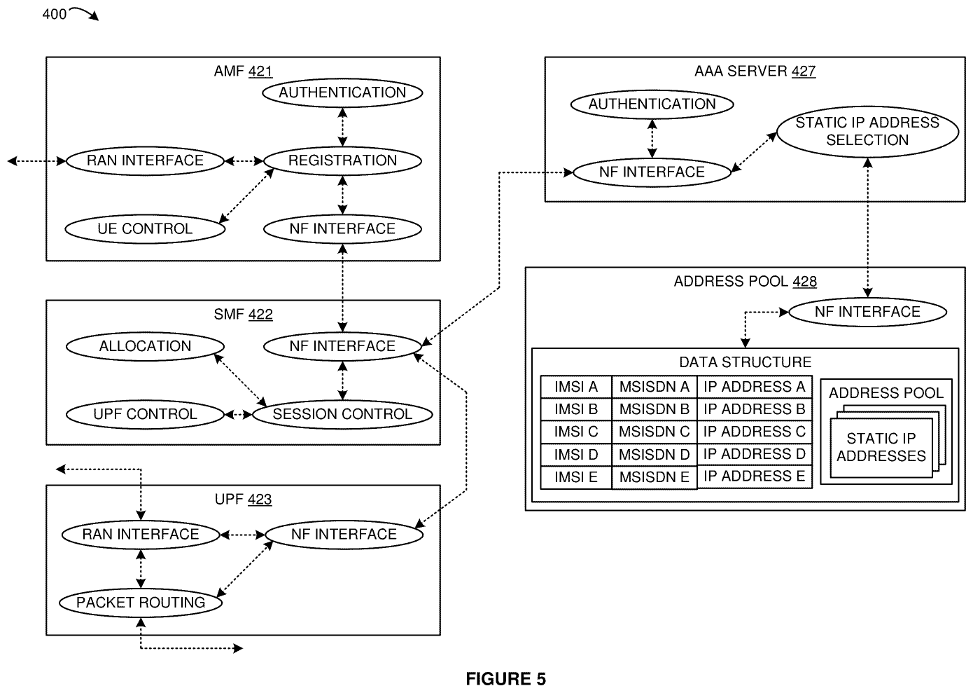

FIG. 5 illustrates AMF 421, SMF 422, UPF 423, AAA server 427, and address pool 428 in 5G communication network 400. AMF 421 comprises modules for network function (NF) interfacing, RAN interfacing, UE control registration, and authentication. The registration module processes registration requests received from UEs, generates context for the registrations, and registers UEs for service responsive to authentication. The authentication module provides authentication challenges and confirms authentication responses to authenticate UEs. The UE control module manages the connection and mobility status (e.g., handover control) for UEs.

SMF 422 comprises modules for network function interfacing, session control, UPF control, and IP address allocation. The session control module activates PDU sessions, enforces session policies (e.g., AMBR), and initiates secondary authentication/static IP address allocation for UEs. The UPF control module selects and manages UPFs to support PDU sessions. The address allocation module allocates static and dynamic IP addresses to UEs. When a UE static IP address assignment is required, the session control module communicates with AAA server 427 to select the static IP address and the address allocation module allocates the selected static IP address to the UE (e.g., by forwarding the address to UPF 423, RAN 411, UE 401, and the like). UPF 423 comprises modules for network function interfacing, RAN interfacing, and packet routing. The packet routing module routes packets between UEs and enterprise network 441 based on allocated IP address.

AAA server 427 comprises modules for network function interfacing, secondary authentication, and static IP address selection. The authentication module validates UE requests for PDU sessions with enterprise network 441 by correlating device IMSIs with MSISDNs associated with enterprise network 441. The static IP address selection module selects static IP addresses for authenticated UEs from a pool of static IP addresses reserved for enterprise network 441 and creates bindings between IMSIs, MSISDNs, and the selected static IP addresses. Address pool 428 comprises a network function interfacing module and stores a data structure. As illustrated in FIG. 5, data structure stores a pool of available static IP addresses and stores bindings that associate IMSIs A-E, MSISDNs A-E, and static IP addresses A-E. The IMSIs are stored in association with the MSISDNs and static IP addresses. For example, IMSI A is stored in association with MSISDN A which is stored in association with static IP address A. Address pool 428 creates bindings responsive to direction from AAA server 428. The static IP address selection module may query the data structure with an IMSI for a UE and the data structure may return the corresponding static IP address and MSISDN. The pool of static IP addresses is reserved for devices associated with enterprise network 441. In some examples, a portion of the static IP addresses are active and available for assignment to UEs while another portion of the static IP addresses are on standby to ensure that there is a backup pool of available addresses in case of any issues with the active address pool.

The network function interface and RAN interface modules allow the network functions to communicate with each other, with RAN 411 and non-3GPP access node 412, and with external systems. For example, the interface modules may comprise Application Programing Interfaces (APIs).

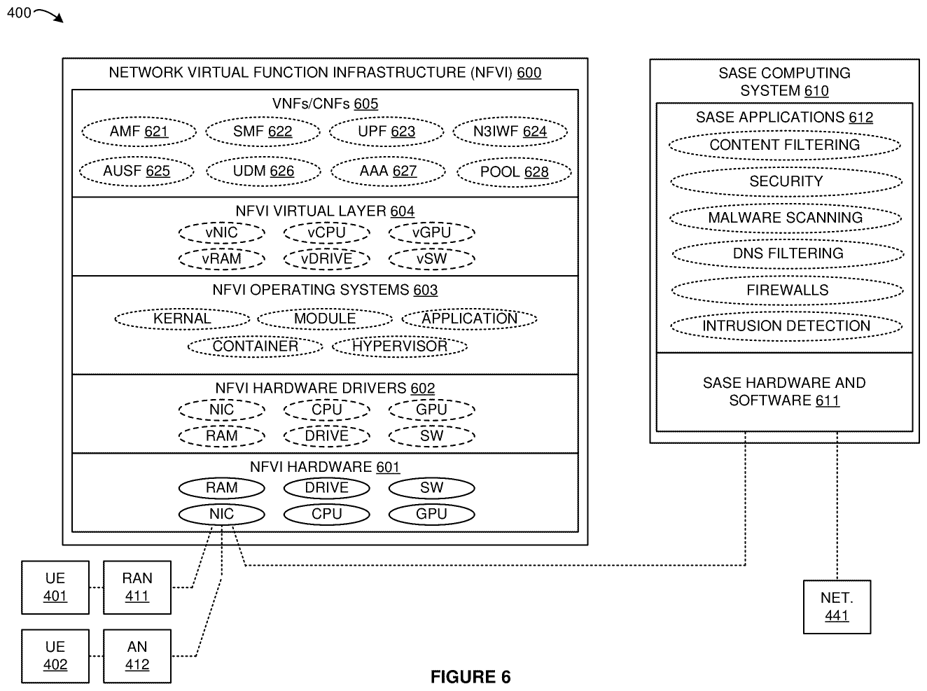

FIG. 6 illustrates Network Function Virtualization Infrastructure (NFVI) 600 and SASE computing system 610 in 5G wireless communication network 400. NFVI 600 comprises an example of core network 120 illustrated in FIG. 1, although core network 120 may differ. NFVI 600 comprises NFVI hardware 601, NFVI hardware drivers 602, NFVI operating systems 603, NFVI virtual layer 604, and NFVI Virtual Network Functions (VNFs)/Cloud-Native Network Functions (CNFs) 605. NFVI hardware 601 comprises Network Interface Cards (NICs), CPU, GPU, RAM, Flash/Disk Drives (DRIVE), and Data Switches (SW). NFVI hardware drivers 602 comprise software that is resident in the NIC, CPU, GPU, RAM, DRIVE, and SW. NFVI operating systems 603 comprise kernels, modules, applications, containers, hypervisors, and the like. NFVI virtual layer 604 comprises vNIC, vCPU, vGPU, vRAM, vDRIVE, and vSW. NFVI VNFs/CNFs 605 comprise AMF 621, SMF 622, UPF 623, N3IWF 624, AUSF 625, UDM 626, AAA 627, and pool 628. Additional VNFs and network elements like PCF, SMSF, NSSF, NEF, NRF, and AF are typically present but are omitted for clarity.

SASE computing system 610 comprises an example of edge security service 131 illustrated in FIG. 1, although edge security service 131 may differ. SASE computing system 610 comprises SASE hardware and software 611 and SASE applications 612. SASE hardware and software 611 comprises NICs, CPU, GPU, RAM, DRIVE, and SW and hardware drivers resident in the NIC, CPU, GPU, RAM, DRIVE, and SW. SASE hardware and software 611 comprises operating systems like kernels, modules, applications, containers, and hypervisors as well as a virtual layer that comprises vNIC, vCPU, GPU, vRAM, vDRIVE, and vSW. SASE applications 612 comprise applications for content filtering, security, malware scanning, DNS filtering, firewalls, and intrusion detection. Additional SASE applications are typically present but are omitted for clarity.

SASE computing system 610 comprises a unified, cloud-native approach to security, merging multiple functions into a single service, which contrasts with the fragmented nature of traditional network routing and security architectures. SASE computing system 610 ensures real-time, context aware policy enforcement, securing user and device traffic and enhancing user experience when compared to other security solutions. SASE computing system 610's inherent flexibility, cost efficiency, and zero trust architecture surpasses the capabilities of traditional firewalls or VPNs, making it appropriate for expanded business needs. By consolidating security functions for end-users, remote IoT devices, branches and offices, SASE computing system 610 not only simplifies the security landscape but also future-proofs organizations against evolving challenges.

SASE computing system 610 combines network security functions with WAN capabilities to support organizations' dynamic, secure access needs. SASE computing system 610 may support security features like Zero Trust Network Access (ZTNA), Secure Web Gateways (SWG), Cloud Access Security Brokers (CASB), and Firewall as a Service (FWaaS), among others. This integrated approach allows organizations to provide secure and optimized connectivity to cloud services, applications, and resources from any location or device. SASE computing system 610 decentralizes the security and networking architecture, ensuring remote and mobile users can connect directly to their destinations without being routed through a centralized data center. This eliminates the need for backhauling, which traditionally rerouted traffic through a central point to access internal applications and apply security, increasing latency from the added transport distance. With SASE computing system 610, users experience faster and more efficient connectivity, remaining as local as possible, enhancing productivity and user experience.

NFVI 600 and SASE computing system 610 may be co-located, each located at a single site, or be distributed across multiple geographic locations. The NIC in NFVI hardware 601 is coupled to 5G RAN 411, non-3GPP access node 412, the NIC in SASE hardware and software 611, and to external systems (not illustrated). The NIC in SASE hardware and software 611 is coupled to the NIC in NFVI hardware 601 and to enterprise network 441. The link between NFVI 600 and SASE computing system 610 may comprise a direction connection or an indirect connection. NFVI hardware 601 executes NFVI hardware drivers 602, NFVI operating systems 603, NFVI virtual layer 604, and NFVI VNFs/CNFs 605 to form AMF 421, SMF 422, UPF 423, N3IWF 424, AUSF 425, UDM 426, AAA server 427, and address pool 428. The hardware in SASE hardware and software and software 611 executes the hardware drives, operating systems, virtual layer, and SASE applications 612 to form the SASE applications illustrated in FIG. 6.

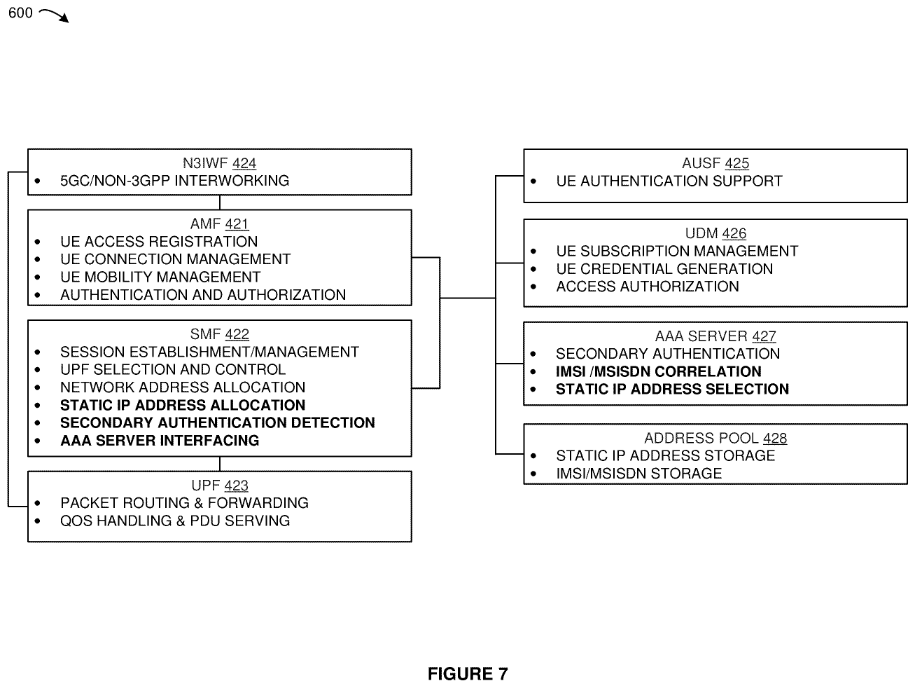

FIG. 7 further illustrates NFVI 600 in 5G communication network 400. AMF 421 comprises capabilities for UE registration, UE connection management, UE mobility management, authentication, and authorization. SMF 422 comprises capabilities for session establishment, session management, UPF selection, UPF control, network address allocation, static IP address allocation, secondary authentication detection, and AAA server interfacing. UPF 423 comprises capabilities for packet routing, packet forwarding, QoS handling, and PDU serving. N3IWF 424 comprises capabilities for 5GC/non-3GPP interworking. AUSF 425 comprises capabilities for UE authentication support. UDM 426 comprises capabilities for UE subscription management, UE credential generation, and UE access authorization. AAA server 427 comprises capabilities for secondary authentication, IMSI/MSISDN correlation, and static IP address selection. Address pool 428 comprises capabilities for static IP address storage and IMSI/MSISDN storage.

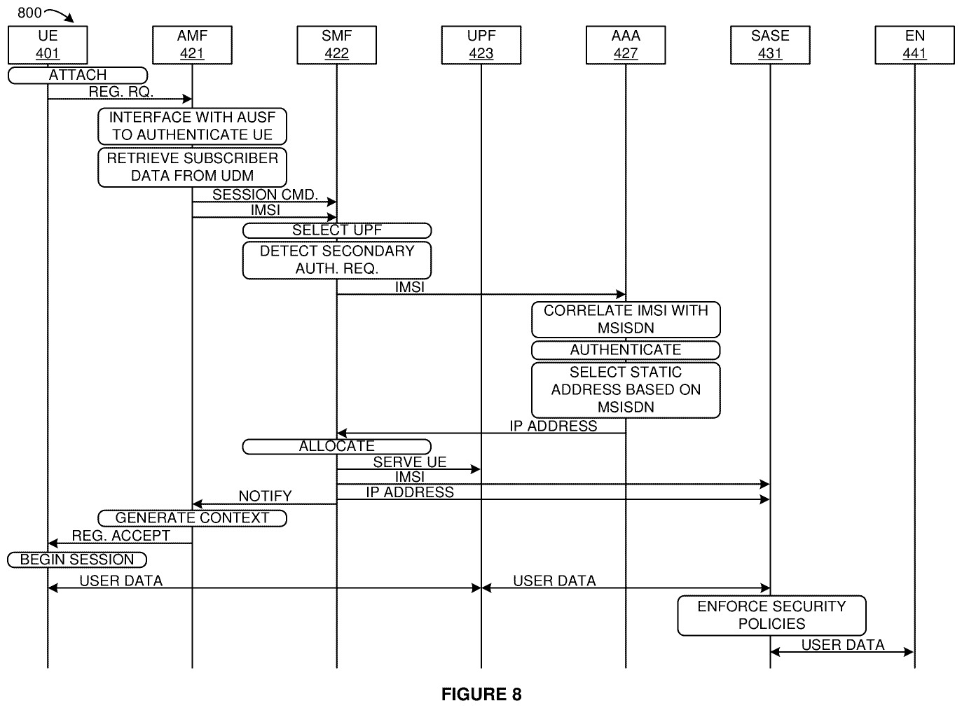

FIG. 8 illustrates process 800. Process 800 comprises an exemplary operation of 5G communication network 400 to assign static IP addresses for edge-based security service. Process 800 comprises an example of processes 200 and 300 illustrated in FIGS. 2 and 3, however processes 200 and 300 may differ. Process 800 may vary in other examples. In some examples, UE 401 wirelessly attaches to 5G RAN 411 and transfers a registration request to AMF 421 over 5G RAN 411. The registration request includes a request for a PDU session with enterprise network 441. In response to the registration request, AMF 421 interfaces with AUSF 425 to authenticate the identity of UE 401. During the authentication process, AUSF 425 provides the SUCI of UE 401 to UDM 426 which converts the SUCI into a SUPI that comprises the IMSI of UE 401. AUSF 425 provides UE 401's SUPI to AMF 421.

Responsive to the authentication, AMF 421 retrieves access and mobility subscription data, SMS selection subscription data, and UE context in SMF data from UDM 426. UDM 426 provides the requested data based on the SUPI/IMSI of UE 401. The access and mobility subscription data, SMS selection subscription data, and/or UE context in SMF data indicates UE 401 is subscribed for secondary authentication with AAA server 427, static IP address assignment, and edge-based security service over SASE 431. AMF 421 forms the UE context for UE 401 using the retrieved information. AMF 421 selects SMF 422 to serve UE 401 based on SMF selection data and transfers a session command (CMD) to SMF 422. The session command includes the list of requested PDU sessions for UE 401, a session activation command, and the SUPI/IMSI of UE 401. AMF 421 notifies SMF 422 that UE 401 is subscribed for secondary authentication, static IP address assignment, and service over SASE 431.

SMF 422 receives the session command and responsively selects UPF 423 to support the PDU sessions. SMF 422 initiates secondary authentication with AAA server 427 and static IP address assignment based on the notification from AMF 421. SMF 422 transfers a request to AAA server 427 to authorize UE 401 for a PDU session on enterprise network (EN) 441. The request indicates UE 401's SUPI/IMSI to AAA server 427 and requests static IP address assignment. AAA server 427 queries address pool 428 to determine if UE 401's IMSI is associated with an MSISDN registered with enterprise network 441. Address pool 428 compares UE 401's IMSI to the data structure and confirms UE 401 is authorized for service on enterprise network 441. In response to authentication/authorization, AAA server 427 selects a static IP address from a pool of available static IP addresses allocated to enterprise network 441. AAA server 427 creates a binding between the selected static IP address and the MSISDN associated with the IMSI of UE 401. AAA server 427 stores the MSISDN/address binding in the data structure hosted by address pool 428. AAA server 427 notifies SMF 422 that UE 401's PDU session with enterprise network 441 is authorized and indicates the selected static IP address.

SMF 422 allocates the static IP address to UE 401 for the requested PDU sessions and allocates a TEID for the session. SMF 422 transfers a session modification request to UPF 423 to set up the default bearer for UE 401. The request includes the TEID and UE 401's static IP address. UPF 423 sets up a default bearer between UE 401, SASE 431, and enterprise network 441. SMF 422 forwards an accounting message to SASE 431 over UPF 423 to enable edge-based security for the PDU session. The accounting message specifies UE 401's IMSI and MSISDN, a session start time, a session stop time. SASE 431 selects security policies based on the received data. For example, SASE 431 may determine the PDU session for UE 401 is authorized for contenting filtering and malware scanning policies based on the IMSI of UE 401.

SMF 422 notifies AMF 421 that the default bearer is set up and indicates the static IP address for UE 401. In response, AMF 421 registers UE 401 for service on network 400 and transfers a registration accept message to UE 401. The registration accept message comprises the UE context, the static IP address, and directs UE 401 to begin its PDU session with enterprise network 401. In response, UE 401 launches a user application (e.g., a media streaming application) to begin the PDU session. UE 401 wirelessly exchanges user data for the PDU session with UPF 423 over RAN 411. UPF 423 exchanges the data with SASE 431. SASE 431 enforces security policies on the exchanged data. SASE 431 exchanges the user data with enterprise network 441. Enterprise network 441, SASE 431, and UPF 423 route the data to UE 401 based on the static IP address allocated to UE 401.

The wireless data network circuitry described above comprises computer hardware and software that form special-purpose network circuitry to assign static IP addresses for edge-based security service. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose network circuitry to assign static IP addresses for edge-based security service.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method, comprising:
authenticating, by a control plane in a communication network, a subscriber Identifier (ID) for a user device received in a registration request;
in response to authentication, detecting, by the control plane, that the user device qualifies for an edge-based security service and static Internet Protocol (IP) address assignment;
mapping, by an authentication server in the communication network, the subscriber ID for the user device to a static IP address and assigning the static IP address to the user device;
providing, by a user plane in the communication network, the static IP address and the subscriber ID to the edge-based security service; and
exchanging, by the user plane, user data with the user device and with the edge-based security service wherein the edge-based security service enforces security policies for a data session of the user device on the communication network.

2. The method of claim 1 wherein detecting that the user device qualifies for the edge-based security service and the static IP address assignment comprises accessing a subscriber profile associated with the user device and retrieving subscriber attributes that authorize the edge-based security service and authorize the static IP address assignment.

3. The method of claim 1 wherein mapping the subscriber ID for the user device to the static IP address and assigning the static IP address to the user device comprises:
maintaining a data repository that stores static IP addresses in association with Mobile Station International Subscriber Directory Numbers (MSISDNs);
correlating an International Mobile Subscriber Identity (IMSI) for the user device with one of the MSISDNs;
authenticating the user device for the static IP address assignment based on the correlation, and
selecting the static IP from a pool of available static IP addresses and storing a binding that associates the static IP address with the one of the MSISDNs for the user device.

4. The method of claim 3 wherein the pool of available static IP addresses is reserved for a third-party system associated with the user device.

5. The method of claim 1 wherein providing the static IP address and the subscriber ID to the edge-based security service comprises transferring an accounting message that comprises an International Mobile Subscriber Identity (IMSI) for the user device, Mobile Station International Subscriber Directory Number (MSISDN) for the user device, session start information, and session stop information.

6. The method of claim 1 wherein the edge-based security service comprises a Secure Access Service Edge (SASE) for a third-party system associated with the user device.

7. The method of claim 1 wherein:
the control plane comprises at least one of an Access and Mobility Management Function (AMF), a Session Management Function (SMF), and an Authentication Server Function (AUSF);
the authentication server comprises an Authentication, Authorization, and Accounting (AAA) server; and
the user plane comprises a User Plane Function (UPF).

8. A communication network comprising:
a network controller configured to:
authenticate a subscriber Identifier (ID) for a user device received in a registration request; and
in response to authentication, detect that the user device qualifies for an edge-based security service and static Internet Protocol (IP) address assignment;
an authentication server configured to:
map the subscriber ID for the user device to a static IP address and assign the static IP address to the device; and
a user plane configured to:
provide the static IP address and the subscriber ID to the edge-based security service; and
exchange user data with the user device and with the edge-based security service wherein the edge-based security service enforces security policies for a data session of the user device on the communication network.

9. The communication network of claim 8 wherein the network controller is configured to access a subscriber profile associated with the user device and retrieve subscriber attributes that authorize the edge-based security service and authorize the static IP address assignment.

10. The communication network of claim 8 wherein the authentication server is configured to:
maintain a data repository that stores static IP addresses in association with Mobile Station International Subscriber Directory Numbers (MSISDNs);
correlate an International Mobile Subscriber Identity (IMSI) for the user device with one of the MSISDNs;
authenticate the user device for the static IP address assignment based on the correlation, and
select the static IP from a pool of available static IP addresses and store a binding that associates the static IP address with the one of the MSISDNs for the user device.

11. The communication network of claim 10 wherein the pool of available static IP addresses is reserved for a third-party system associated with the user device.

12. The communication network of claim 8 wherein the user plane is configured to transfer an accounting message that comprises an International Mobile Subscriber Identity (IMSI), a Mobile Station International Subscriber Directory Number (MSISDN) for the user device, session start information, and session stop information.

13. The communication network of claim 8 wherein the edge-based security service comprises a Secure Access Service Edge (SASE) for a third-party system associated with the user device.

14. The communication network of claim 8 wherein:
the network controller comprises at least one of an Access and Mobility Management Function (AMF), a Session Management Function (SMF), and an Authentication Server Function (AUSF);
the authentication server comprises an Authentication, Authorization, and Accounting (AAA) server; and
the user plane comprises a User Plane Function (UPF); and further comprising:
a Network Function Virtualization Infrastructure configured to execute the AMF, SMF, AUSF, AAA server, and UPF.

15. One or more non-transitory computer readable storage media having program instructions stored thereon, wherein the program instruction, when executed by a computing system, direct the computing system to perform operations, the operations comprising:
authenticating an International Mobile Subscriber Identity (IMSI) for a user device received in a registration request sent by the user device;
in response to authentication, accessing a subscriber profile and determining the user device qualifies for an edge-based security service and static Internet Protocol (IP) address assignment;
mapping the IMSI for the user device to a static IP address and assigning the static IP address to the user device;
providing the static IP address and the IMSI to the edge-based security service;
exchanging user data with the user device and with the edge-based security service for a data session of the user device on the communication network wherein the edge-based security service enforces security policies for the data session of the user device on the communication network.

16. The computer readable storage media of claim 15 wherein accessing the subscriber profile and determining the user device qualifies for the edge-based security service and static IP address assignment comprises retrieving subscriber attributes for the subscriber profile that authorize the edge-based security service and authorize the static IP address assignment.

17. The computer readable storage media of claim 15 wherein mapping the IMSI for the user device to the static IP address and assigning the static IP address to the user device comprises:
maintaining a data repository that stores static IP addresses in association with Mobile Station International Subscriber Directory Numbers (MSISDNs);
correlating the IMSI for the user device with one of the MSISDNs;
authenticating the device for the static IP address assignment based on the correlation, and
selecting the static IP from a pool of available static IP addresses and storing a binding that associates the static IP address with the one of the MSISDNs for the user device.

18. The computer readable storage media of claim 17 wherein the pool of available static IP addresses is reserved for an enterprise network associated with the user device.

19. The computer readable storage media of claim 15 wherein providing the static IP address and the IMSI to the edge-based security service comprises transferring an accounting message that comprises the IMSI, a Mobile Station International Subscriber Directory Number (MSISDN) for the user device, session start information, and session stop information.

20. The computer readable storage media of claim 15 wherein:
the edge-based security service comprises a Secure Access Service Edge (SASE) for an enterprise network associated with the user device;
the data session comprises a Protocol Data Unit (PDU) session; and
the SASE enforces security policies for the PDU session between the user device and the enterprise network.
